(19) United States
(12) Patent Application Publication
(10) Pub. No.: US 2019/0148729 A1
(43) Pub. Date: May 16, 2019

(54) ELECTRODE FOR SODIUM-ION BATTERY

(71) Applicant: QATAR FOUNDATION FOR EDUCATION, SCIENCE AND COMMUNITY DEVELOPMENT, DOHA (QA)

(72) Inventors: RACHID ESSEHLI, DOHA (QA); HAMDI BEN YAHIA, DOHA (QA); ILIAS BELHAROUAK, DOHA (QA)

(21) Appl. No.: 16/192,306

(22) Filed: Nov. 15, 2018

Related U.S. Application Data
(60) Provisional application No. 62/586,796, filed on Nov. 15, 2017.

(51) Int. Cl. H01M 4/58; H01M 4/62; H01M 10/054

(52) U.S. Cl. CPC H01M 4/5825; H01M 10/054; H01M 4/625

(57) ABSTRACT

The electrode for a sodium-ion battery is a fluorine-doped sodium metal hydroxide phosphate having the general formula Na₃₊ₓV₂₋ₓMₓ(PO₄)₂F₃, wherein “M” is a divalent metal selected from the group consisting of Mg, Cr, Mn, Fe, Co, Ni, and Cu and 0<x≤1. Materials comprising such compounds can be used as positive electrode materials for rechargeable sodium-ion batteries. The compounds of the present disclosure may be produced by a hydrothermal synthesis route, or by sol-gel or solid-state synthesis.

### CROSS-REFERENCE TO RELATED APPLICATIONS

This application claims the benefit of U.S. Provisional Patent Application Ser. No. 62/586,796, filed Nov. 15, 2017.

### BACKGROUND

### 1. Field

The disclosure of the present patent application relates to sodium-ion batteries, and particularly to an electrode for a sodium-ion battery that is a fluorinated sodium metal phosphate compound that can be used in a positive electrode for a rechargeable sodium-ion battery.

### 2. Description of the Related Art

Lithium-ion rechargeable batteries have been commercially available for several years. However, lithium metal is a scarce resource, and with demand for lithium-ion batteries constantly increasing, the price of lithium has been steadily increasing. Consequently, there is renewed interest in developing a sodium-ion battery, since the two elements have similar properties, but sodium is cheaper and more readily available. In one important respect, however, sodium is different from lithium, viz., sodium is a larger atom than lithium. The effect of this difference in size is that sodium ions are not transported through electrolyte as quickly as lithium ions, causing a slower response to a sudden demand for current. Hence, some of the technology developed for lithium electrodes and electrodes does not carry over directly to electrodes and electrolytes for sodium-ion batteries. There is a need for developing electrodes and electrolytes having properties consistent with their use in sodium-ion batteries.

Thus, an electrode for a sodium-ion battery solving the aforementioned problems is desired.

### SUMMARY

The electrode for a sodium-ion battery is a fluorinated sodium metal phosphate having the general formula Na₃₊ₓV₂₋ₓMₓ(PO₄)₂F₃, wherein “M” is a divalent metal selected from the group consisting of Mg, Cr, Mn, Fe, Co, Ni, and Cu and 0<x≤1. Materials comprising such compounds can be used as positive electrode materials for rechargeable sodium-ion batteries. The compounds of the present disclosure may be produced by a hydrothermal or a solid-state synthesis route.

These and other features of the present disclosure will become readily apparent upon further review of the following specification.

### BRIEF DESCRIPTION OF THE DRAWINGS

FIG. 1 is an exemplary diffractogram showing a powder X-ray diffraction pattern (PXRD) for the electrode material of formula Na_{3.2}V_{1.8}Ni_{0.2}(PO₄)₂F₃, synthesized as described herein.

FIG. 2 is a scanning electron micrograph (SEM) image of an electrode material of formula Na_{3.2}V_{1.8}M_{0.2}(PO₄)₂F₃ synthesized as described herein where M is manganese.

FIG. 3 is a scanning electron micrograph (SEM) image of an electrode material of formula Na_{3.2}V_{1.8}M_{0.2}(PO₄)₂F₃ synthesized as described herein where M is iron.

FIG. 4 is a scanning electron micrograph (SEM) image of an electrode material of formula Na_{3.2}V_{1.8}M_{0.2}(PO₄)₂F₃ synthesized as described herein where M is cobalt.

FIG. 5 is a scanning electron micrograph (SEM) image of an electrode material of formula Na_{3.2}V_{1.8}M_{0.2}(PO₄)₂F₃ synthesized as described herein where M is nickel.

FIG. 6 is a plot showing an energy dispersive X-ray (EDX) spectrograph of the exemplary electrode material of formula Na_{3.5}V_{1.5}Ni_{0.5}(PO₄)₂F₃, synthesized as described herein.

FIG. 7 is a cyclic voltammetry trace of the cycling performance of the electrode material of formula Na_{3.2}V_{1.8}Fe_{0.2}(PO₄)₂F₃, synthesized as described herein, recorded at 0.1 mV s⁻¹.

FIG. 8A is a voltammetry trace of galvanostatic charge-discharge curves of the electrode material of formula Na_{3.2}V_{1.8}Fe_{0.2}(PO₄)₂F₃, synthesized as described herein.

FIG. 8B is a cyclic voltammetry trace showing the cycling performance of the electrode material of formula Na_{3.2}V_{1.8}Fe_{0.2}(PO₄)₂F₃, synthesized as described herein, recorded at 0.1 C.

FIG. 9 is a cyclic voltammetry trace showing the cycling performance of the electrode material of formula Na_{3.2}V_{1.8}Ni_{0.2}(PO₄)₂F₃, synthesized as described herein, recorded at 0.1 C.

FIG. 10A is a voltammetry trace of galvanostatic charge-discharge curves of the electrode material of formula Na_{3.2}V_{1.5}Ni_{0.5}(PO₄)₂F₃, synthesized as described herein.

FIG. 10B is a cyclic voltammetry trace showing the cycling performance of the electrode material of formula Na_{3.5}V_{1.5}Ni_{0.5}(PO₄)₂F₃, synthesized as described herein, recorded at 0.1 C.

FIG. 11 is a voltammetry trace of galvanostatic charge-discharge curves and cycling performance at a rate of 0.1 C of the electrode material of formula Na_{3.2}V_{1.8}Co_{0.2}(PO₄)₂F₃, synthesized as described herein.

Similar reference characters denote corresponding features consistently throughout the attached drawings.

### DETAILED DESCRIPTION OF THE PREFERRED EMBODIMENTS

The electrode for a sodium-ion battery is a fluorinated sodium metal phosphate having the general formula Na₃₊ₓV₂₋ₓMₓ(PO₄)₂F₃, wherein “M” is a divalent metal selected from the group consisting of Mg, Cr, Mn, Fe, Co, Ni, and Cu and 0<x≤1. The compound from which the electrode is made is preferably in a solid-state form.

The compounds of the present disclosure may be made by hydrothermal or solid-state synthesis, as described in the following examples.

### Example 1

### Synthesis of Na₃₊ₓV₂₋ₓMₓ(PO₄)₂F₃ Electrode Material by Hydrothermal Method

The Na₃+₈V₂₋ₓMₓ(PO₄)₂F₃ compounds [wherein “M” is a divalent cation that can be chosen from, but is not limited to, Mg, Cr, Mn, Fe, Co, Ni, Cu, and (0<x≤1)] were successfully prepared using a hydrothermal method from stoichiometric mixtures of NaF (Aldrich, ≥99%), NH₄VO₃ (Aldrich, ≥99.99%), M(CH₃COO)₃.xH₂O, (Aldrich, ≥99.99%), NH₄H₂PO₄ (Aldrich, 99.99%) and citric acid (C₆H₈O₇) (CA). CA was employed as carbon source and reducing agent. First NH₄VO₃ and CA with a mole ratio of 1:2 were dissolved in 40 ml of water to form a clear blue solution, and then M(CH₃COO)₃.xH₂O was added (Solution A). The NaF and NH₄H₂PO₄ were dissolved together in 40 ml of H₂O (Solution B). Solution B was then added dropwise to solution A under continuous stirring. The solution is finally poured in a 100 mL autoclave, which was then heated at 200° C. for 20 h. The powder obtained after filtering the solution was dried at 100° C. for 12 h under vacuum. The progress of the reaction was followed by PXRD.

### Example 2

### Synthesis of Na₃₊ₓV₂₋ₓMₓ(PO₄)₂F₃ Electrode Material by Sol-Gel or Solid-State Method

The Na₃₊ₓV₂₋ₓMₓ(PO₄)₂F₃ compounds [wherein “M” is a divalent cation that can be chosen from, but is not limited to, Mg, Cr, Mn, Fe, Co, Ni, Cu, and (0<x≤1)] were also successfully prepared using a sol-gel method from stoichiometric mixtures of NaF (Aldrich, ≥99%), NH₄VO₃ (Aldrich, ≥99.99%), NH₄H₂PO₄ (Aldrich, 99.99%) and citric acid (C₆H₈O₇) (CA). CA was employed as carbon source and reducing agent. First NH₄VO₃ and CA were dissolved in 100 ml of water to form a clear blue solution (Solution A). M(CH₃COO)₃xH₂O (Aldrich, ≥99.99%) is dissolved in 50 ml of water and then added to Solution A. The NaF and NH₄H₂PO₄ were mixed together under continuous stirring in 50 ml of H₂O (Solution B). Solution B was then added dropwise to solution A under continuous stirring. The resulting solution was then slowly evaporated to dryness at 100° C. The residue was ground in an agate mortar and heated in Ar atmosphere in an alumina crucible at 400° C. for 24 h and at 650° C. for 24 h.

In the above syntheses, the precursors for the synthesis can also be replaced as follows: (1) NH₄VO₃ may be replaced by VOSO₄, VCl₃.xH₂O, VOC₂O₄, V₂O₅, V₂O₃, or VO₂; (2) M(CH₃COO)₃.xH₂O may be replaced by MSO₄,xH₂O, M(NO₃)₂.xH₂O, or MCl₂.xH₂O; (3) NH₄H₂PO₄ may be replaced by (NH₄)₂HPO₄, H₃PO₄, Na₂HPO₄, or NaH₂PO₄; (4) NaF may be replaced by (NH₄)₂F, HF, or MF; and (5) the reducing agent, (RA) is not limited to citric acid (C₆H₈O₇) (CA), but may be replaced by oxalic acid H₂C₂O₄ (OA), Formic acid (HCOOH) or maleic acid C₄H₄O₄.

### Example 3

### Crystallographic Studies of Synthesized Samples

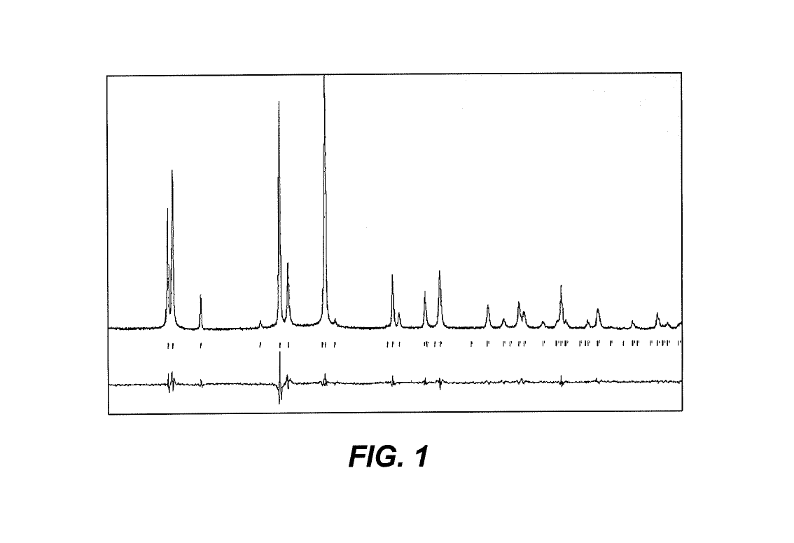

To ensure the purity of the Na₃₊ₓV₂₋ₓMₓ(PO₄)₂F₃ powders, PXRD measurements were performed. The data were collected at room temperature over the 2θ angle range of 10°≤2θ≤70° with a step size of 0.01° using a Bruker d8 Avanced diffractometer operating with CuKα radiations. Full pattern matching refinement was performed with the Jana2006 program package. The background was estimated by a Legendre function, and the peak shapes were described by a pseudo-Voigt function. An exemplary diffractogram for the electrode material of formula Na_{3.2}V_{1.8}Ni_{0.2}(PO₄)₂F₃ is shown in FIG. 1. Evaluation of these data for the various samples of electrode material that were synthesized revealed the refined cell parameters listed in Tables 1 and 2.

TABLE 1
Crystallographic data for Na₃₊ₓV₂₋ₓMₓ(PO₄)₂F₃ compounds

| | Na_{3.5}V_{1.5}Ni_{0.5}(PO₄)₂F₃ | Na_{3.2}V_{1.8}Ni_{0.2}(PO₄)₂F₃ | Na_{3.2}V_{1.8}Mn_{0.2}(PO₄)₂F₃ |
|---|---|---|---|
| a (Å) | 6.39949(8) | 6.39429(18) | 9.03660(14) |
| b (Å) | 6.39949(8) | 6.39429(18) | 9.03660(14) |
| c (Å) | 10.61398(19) | 10.6331(5) | 10.6279(3) |
| V (Å³) | 434.679(11) | 434.75(3) | 867.88(3) |
| Space Group | I4/mmm | I4/mmm | P4₂/mnm |

TABLE 2
Crystallographic data for Na₃₊ₓV₂₋ₓMₓ(PO₄)₂F₃ compounds (cont'd)

| | Na_{3.2}V_{1.8}Fe_{0.2}(PO₄)₂F₃ | Na_{3.2}V_{1.8}Coi_{0.2}(PO₄)₂F₃ |
|---|---|---|
| a (Å) | 9.03204(18) | 6.39956(15) |
| b (Å) | 9.03204(18) | 6.39956(15) |
| c (Å) | 10.6505(4) | 10.6208(4) |
| V (Å³) | 868.84(4) | 434.97(2) |
| Space Group | P4₂/mnm | I4/mmm |

Based on the full pattern matching performed on all the Na₃₊ₓV₂₋ₓMₓ(PO₄)₂F₃ samples, the powder patterns could be indexed either using the space group I4/mmm or P4₂/mnm. This indicates that the crystal structures of our compounds are either isostructural to Na₃Cr₂(PO₄)₂F₃ or Na₃V₂(PO₄)₂F₃, respectively. The main difference between the two structures is the distribution of the sodium atoms within the [V₂(PO₄)₂F₃]³⁻ frameworks, and also the slight distortion of the octahedra containing the vanadium cations. It is worthwhile to mention that all the Na₃M₂(PO₄)₂F_{3-y}O_{y}, also have very similar [M₂(PO₄)₂F₃]³⁻ frameworks, even though they crystallize with different space groups (I4/mmm, P4₂/mnm, P4₂/mbc, Cmcm, Cmc2₁, or Pbam).

### Example 4

### SEM Images and EDX Spectroscopy of Synthesized Samples

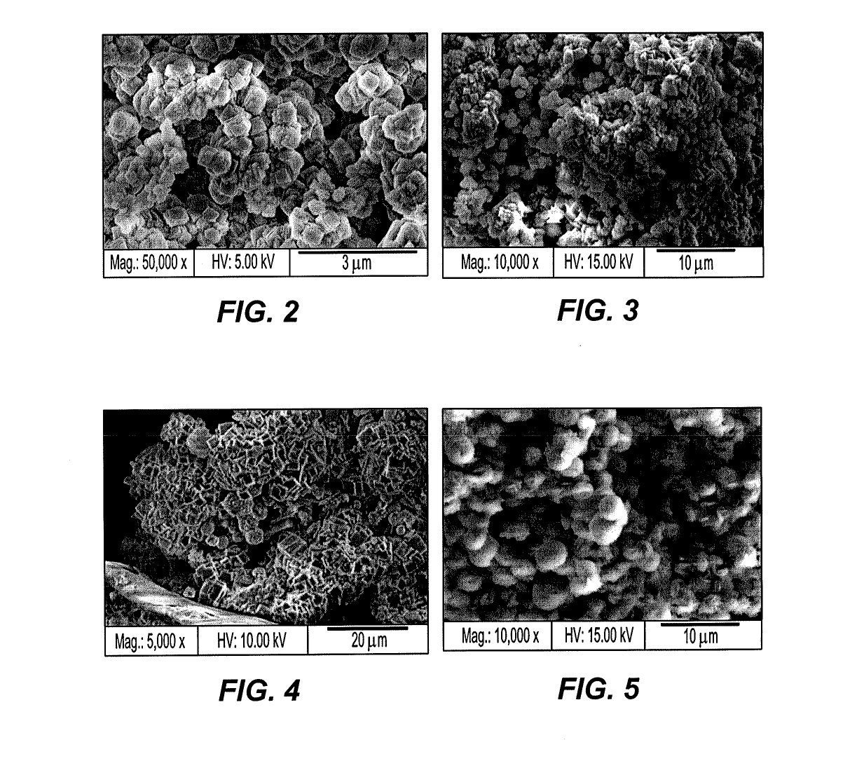

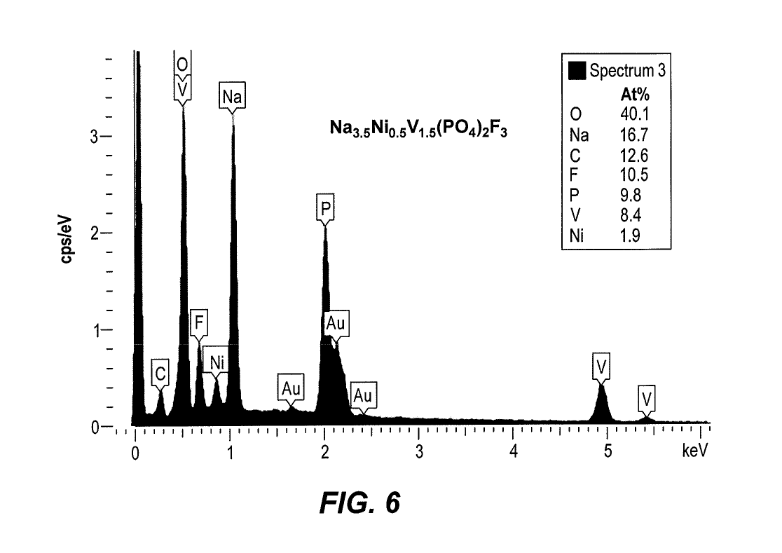

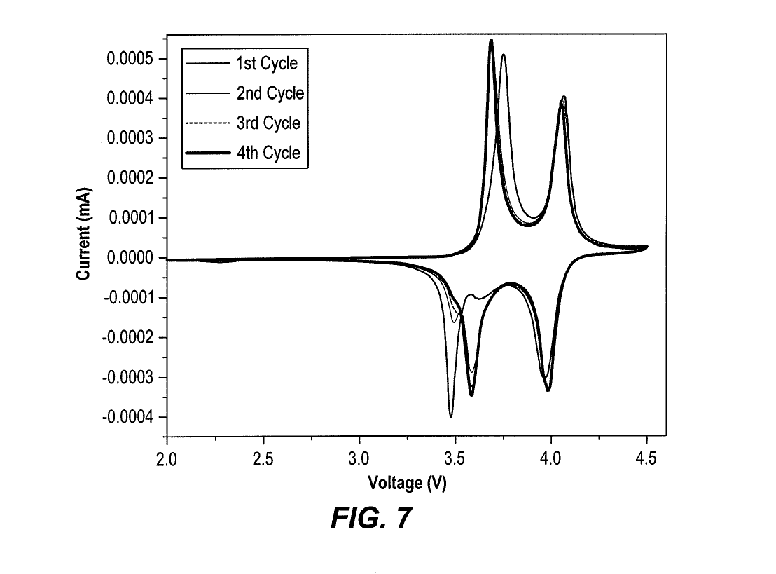

SEM images of exemplary samples of the synthesized electrode material are shown in FIGS. 2-5. Semiquantitative energy dispersive X-ray spectrometry (EDX) analyses of the powder was carried out with a SEM-JSM-7500F scanning electron microscope. The experimentally observed Na/V/M/P molar ratios were close to 3.2:1.8:0.2:2, as expected, for Na_{3.2}V_{1.8}M_{0.2}(PO₄)₂F₃. Analyses were also carried out on Na_{3.5}V_{1.5}Ni_{0.5}(PO₄)₂F₃. The Na/V/M/P molar ratios were close to 3.5:1.5:0.5:2.

### Example 5

### Construction and Testing of Sample Electrodes

Positive electrodes were made from mixtures of Na₃₊ₓV₂₋ₓMₓ(PO₄)₂F₃ powders, acetylene black (AB) and polyvinylidene fluoride (PVDF) in a weight ratio of 80:10:10. The resulting electrode film was pressed with a twin roller, cut into a round plate (Φ=14 mm), and dried at 120° C. for 12 h under vacuum. The electrolyte was 1 M NaPF₆ dissolved in ethylene carbonate (EC) and propylene carbonate (PC) [EC/PC with 1/1 in volume ratio]. Coin-type cells (CR2032) embedding Na₃₊ₓV₂₋ₓMₓ(PO₄)₂F₃/NaPF₆+EC+PC/Na were assembled in an argon-filled glove box with a Whatman GF/C glass fiber separator. Room temperature galvanometric cycling tests (Constant current mode) were performed using Arbin battery tester system in a potential range of 2.5-4.5 V at different rates, whereas the cyclic voltammetry tests were performed using a Solartron battery tester system. All our electrochemical tests were performed in half cells versus Na metal anode.

The electrolyte salts may be selected from, but are not limited to, the group consisting of NaPF₆, NaClO₄, and NaBF₄. The carbonate solvent may be selected from, but is not limited to, the group consisting of ethylene carbonate (EC), propylene carbonate (PC), dimethyl carbonate (DMC), and diethyl carbonate (DEC).

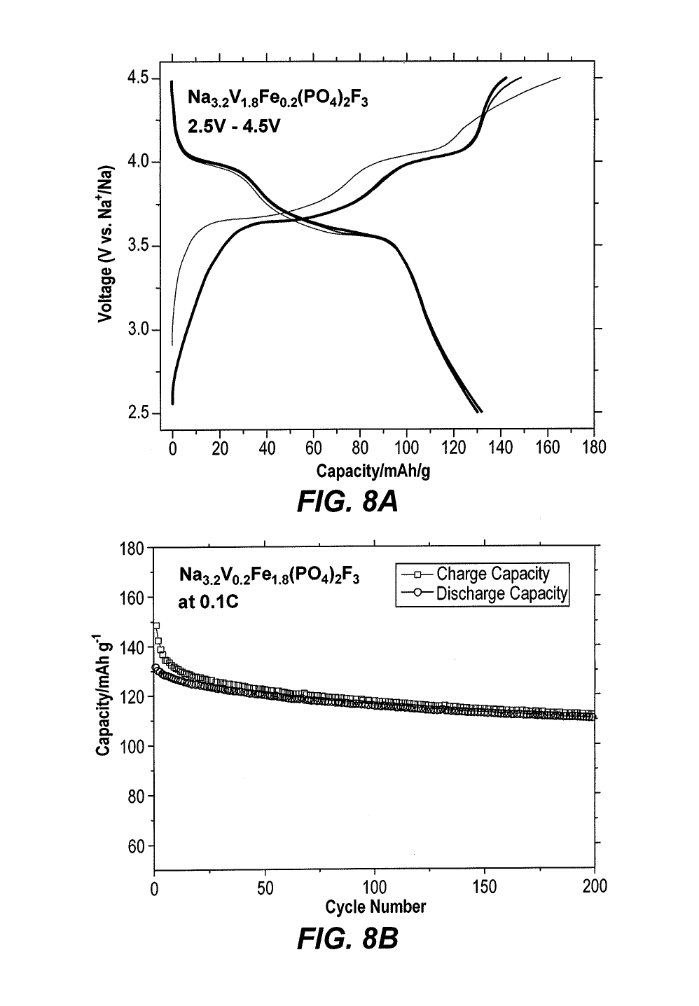

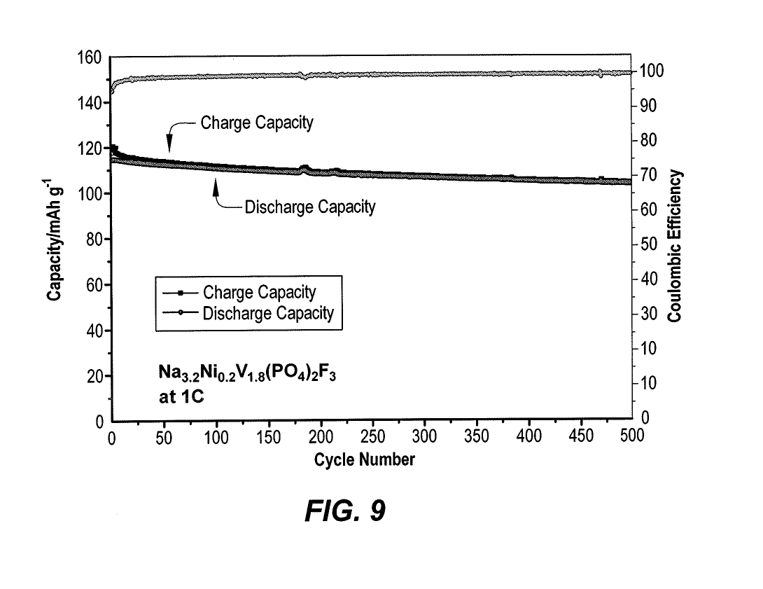

FIG. 9 shows the first four CV cycles for Na_{3.2}Fe_{0.2}V_{1.8}(PO₄)₂F₃ recorded under the 0.1 mV s⁻¹ rate. The cyclic voltammetry test indicates the presence of two reversible peaks at 3.6 and 4.1V, which leads to an average operation voltage of 3.85V, which is higher than those of NaFe₂(SO₄)₂(PO₄) (2.8V) (see Hamdi Ben Yahia et al., “Sodium intercalation in the phosphosulfate cathode NaFe₂(PO₄)(SO₄)₂”, Journal of Power Sources (2018), Vol. 382, pp. 144-15), Na_{1.86}Fe₃(PO₄)₃, (see R. Essehli et al., “Unveiling the sodium intercalation properties in Na_{1.86}□_{0.14}Fe₃(PO₄)₃”, Journal of Power Sources (2016), Vol. 324, pp. 657-664) and Na₄MnV(PO₄)₃ (see U. Nisar et al., “Sodium intercalation/de-intercalation mechanism in Na₄MnV(PO₄)₃ cathode materials”, Electrochimica Acta (2018), Vol. 292, pp. 98). The Galvanostatic charge and discharge curves show that Na_{3.2}Fe_{0.2}V_{1.8}(PO₄)₂F₃ delivers a discharge capacity of 130 mAh/g (FIG. 8A), and the material also shows good cycling performance after 200 cycles (FIG. 8B).

The Galvanostatic charge and discharge curves shows that Na_{3.2}Ni_{0.2}V₁₈(PO₄)₂F₃ delivers a discharge capacity of 115 mAh/g with excellent cycling performance after 500 cycles (FIG. 9). Therefore this material is an excellent candidate for a full cell sodium ion battery fabrication.

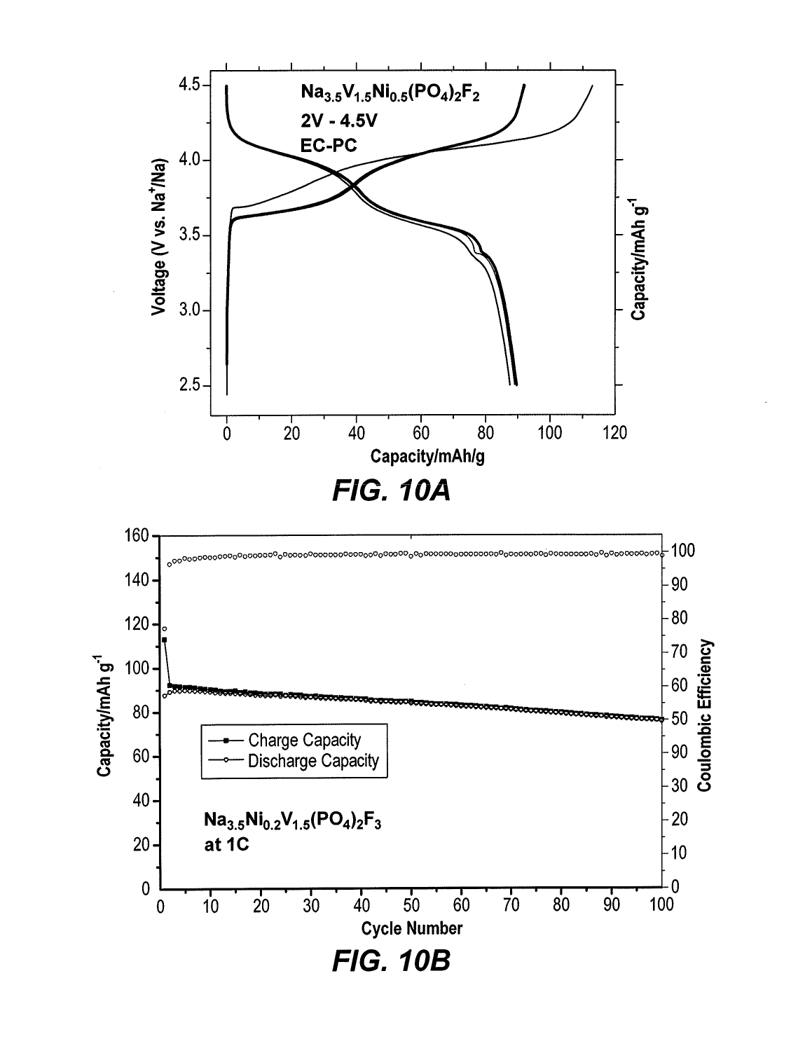

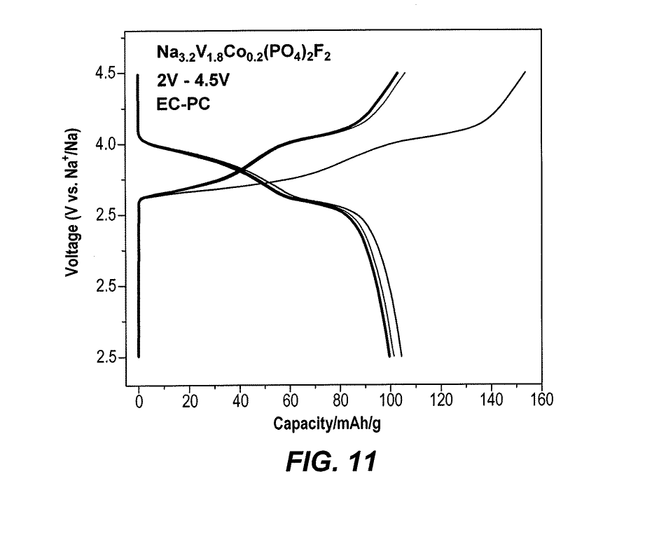

The Galvanostatic charge and discharge curves shows that Na_{3.5}Ni_{0.5}V_{1.5}(PO₄)₂F₃ delivers a discharge capacity of 84 mAh/g at 1 C rate, as shown in FIG. 10A. The material shows also good cycling performance, as shown in FIG. 10B, Na_{3.2}Co_{0.2}V_{1.8}(PO₄)₂F₃ delivers good capacity during the first cycles, as shown in FIG. 11.

Thus, the materials and the compounds may provide electrochemical energy storage of sodium ions by functioning as, for example, positive electrodes for sodium-ion batteries.

A device, typically a battery, may be made with a positive electrode formed from the material or the compound and a negative electrode formed from hard carbon, and further having a sodium-based electrolyte.

It is to be understood that the electrode for a sodium-ion battery is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. An electrode for a sodium-ion battery, comprising a compound of the formula Na₃₊ₓV₂₋ₓMₓ(PO₄)₂F₃, wherein “M” is a divalent metal selected from the group consisting of Mg, Cr, Mn, Fe, Co, Ni, and Cu, and 0<x≤1.

2. The electrode according to claim 1, further comprising a conductive carbon powder and a polymer binder mixed with the compound of the formula Na₃₊ₓV₂₋ₓMₓ(PO₄)₂F₃.

3. The electrode according to claim 1, further comprising acetylene black and polyvinylidene fluoride mixed with the compound of the formula Na₃₊ₓV₂₋ₓMₓ(PO₄)₂F₃, the mixture being pressed to form an electrode body.

4. The electrode according to claim 1, wherein the compound has the formula Na_{3.5}V_{1.5}Ni_{0.5}(PO₄)₂F₃.

5. The electrode according to claim 1, wherein the compound has the formula Na_{3.5}V_{1.5}Ni_{0.5}(PO₄)₂F₃.

6. The electrode according to claim 1, wherein the compound has the formula Na_{3.2}V_{1.8}Mn_{0.2}(PO₄)₂F₃.

7. The electrode according to claim 1, wherein the compound has the formula Na_{3.2}V_{1.8}Fe_{0.2}(PO₄)₂F₃.

8. The electrode according to claim 1, wherein the compound has the formula Na_{3.2}V_{1.8}Coi_{0.2}(PO₄)₂F₃.

9. A sodium-ion battery made with the electrode according to claim 1.

10. A sodium-ion battery, comprising:
the electrode according to claim 1 configured as a positive electrode;
a negative electrode comprising hard carbon; and
a sodium-based electrolyte, the positive electrode and the negative electrode being disposed in contact with the electrolyte.

11. The sodium-ion battery according to claim 10, wherein the electrolyte is a salt selected from the group consisting of NaPF₆, NaClO₄, and NaBF₄.

12. The sodium-ion battery according to claim 11, wherein the electrolyte salt is moistened with a solvent selected from the group consisting of ethylene carbonate (EC), propylene carbonate (PC), dimethyl carbonate (DMC), and diethyl carbonate (DEC).

13. A method of making a compound for use as an electrode in a sodium-ion battery, comprising the steps of:
dissolving citric acid (CA) and NH₄VO₃ in water to form a first solution;
adding M(CH₃COO)₃.xH₂O, wherein M is a divalent metal selected from the group consisting of Mg, Cr, Mn, Fe, Co, Ni, and Cu and x is an integer, to the first solution;
dissolving sodium fluoride (NaF) and ammonium dihydrogen phosphate (NH₄H₂PO₄) in water to form a second solution;
adding the second solution to the first solution dropwise with continuous stirring to form a reaction mixture;
heating the reaction mixture at 200° C. for 20 hours to obtain a precipitate;
filtering the precipitate from the reaction mixture; and
drying the precipitate under vacuum to obtain the compound as a powder.

14. A method of making a compound for use as an electrode in a sodium-ion battery, comprising the steps of:
dissolving citric acid (CA) and NH₄VO₃ in water to form a first solution;
adding M(CH₃COO)₃.xH₂O, wherein M is a divalent metal selected from the group consisting of Mg, Cr, Mn, Fe, Co, Ni, and Cu and x is an integer, to the first solution;
dissolving sodium fluoride (NaF) and ammonium dihydrogen phosphate (NH₄H₂PO₄) in water to form a second solution;
adding the second solution to the first solution dropwise with continuous stirring to form a reaction mixture;
slowly evaporating the reaction mixture to dryness at 100° C. to obtain a residue;
grinding the residue in a mortar;
heating the ground residue in Argon atmosphere at 400° C. for 24 hours;
thereafter, heating the ground residue at 650° C. for an additional 24 hours.
